(19) United States
(12) Patent Application Publication
(10) Pub. No.: US 2020/0160291 A1
(43) Pub. Date: May 21, 2020

(54) System for Performing a Credit Transaction

(71) Applicant: Rashad Jackson, Lawrenceville, GA (US)

(72) Inventor: Rashad Jackson, Lawrenceville, GA (US)

(21) Appl. No.: 16/191,725

(22) Filed: Nov. 15, 2018

(51) Int. Cl. G06Q 20/08; G06Q 20/32; G06Q 20/20; G06Q 20/40; G07F 15/00

(52) U.S. Cl. CPC G06Q 20/0855; G06Q 20/322; G06Q 20/24; G06Q 20/4037; G07F 15/00; G06Q 20/204

(57) ABSTRACT

A system for performing a credit transaction enabling remote payment on behalf of a third party includes a computer network, a payment terminal, and a server. The payment terminal has an identifier so that the payment terminal is uniquely identified. The payment terminal and the server are in communication with the computer network. Processing programming code is positioned on the server that enables the server to derive a merchant bank identity from the identifier, positioning the server to initiate the processing of a credit card transaction and to communicate an issuing bank approval for the credit card transaction to the payment terminal. Interfacing programming code is positioned on an electronic device of a user that enables the user to communicate the identifier and a credit card payment authorization for the credit card transaction, via the computer network, to the server.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relate to systems for performing a transaction and more particularly pertains to a new system for performing a transaction enabling remote payment on behalf of a third party.

### BRIEF SUMMARY OF THE INVENTION

An embodiment of the disclosure meets the needs presented above by generally comprising a computer network, a payment terminal, and a server. The payment terminal has an identifier so that the payment terminal is uniquely identified. The payment terminal and the server are in communication with the computer network. Processing programming code is positioned on the server that enables the server to derive a merchant bank identity from the identifier, positioning the server to initiate the processing of a credit card transaction and to communicate an issuing bank approval for the credit card transaction to the payment terminal. Interfacing programming code is positioned on an electronic device of a user that enables the user to communicate the identifier and a credit card payment authorization for the credit card transaction, via the computer network, to the server.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an in-use view of a system for performing a credit transaction according to an embodiment of the disclosure.

FIG. 2 is a flow diagram of an embodiment of the disclosure.

### DETAILED DESCRIPTION OF THE INVENTION

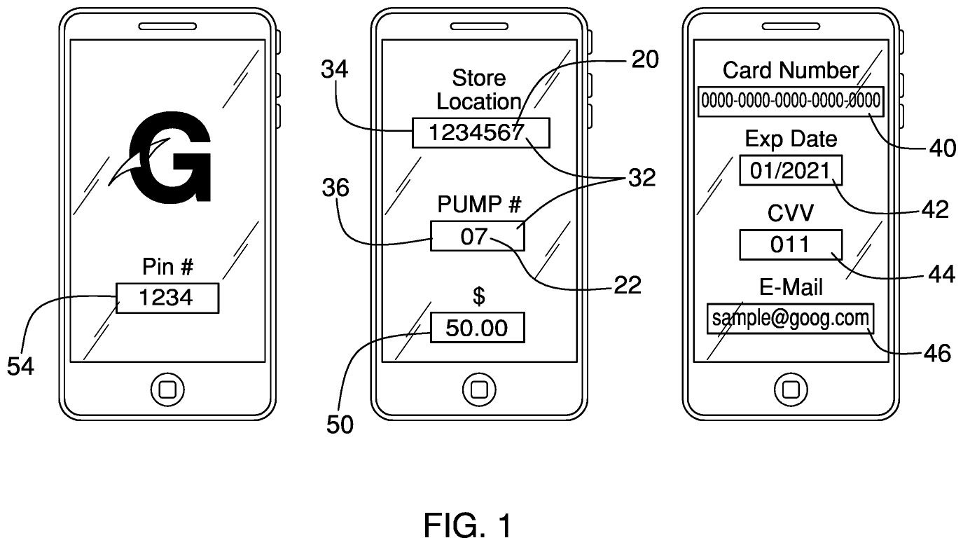

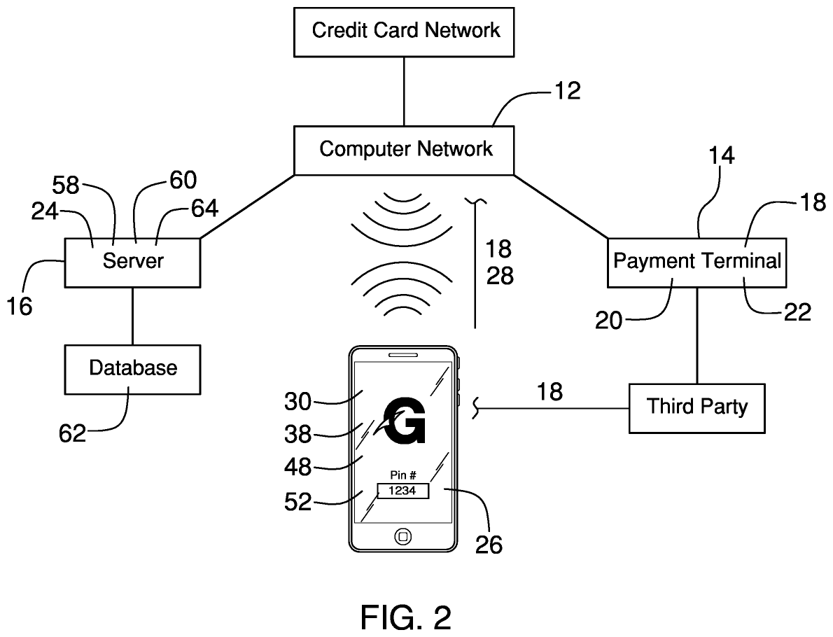

With reference now to the drawings, and in particular to FIGS. 1 and 2 thereof, a new system for performing a transaction embodying the principles and concepts of an embodiment of the disclosure and generally designated by the reference numeral 10 will be described.

As best illustrated in FIGS. 1 and 2, the system for performing a credit transaction 10 generally comprises a computer network 12, a payment terminal 14, and a server 16. The payment terminal 14 has an identifier 18 so that the payment terminal 14 is uniquely identified. The identifier 18 comprises a station number 20 and a pump number 22. The payment terminal 14 and the server 16 are in communication with the computer network 12.

Processing programming code 24 is positioned on the server 16 that enables the server 16 to derive a merchant bank identity from the identifier 18 so that the server 16 is configured to initiate the processing of a credit card transaction and to communicate an issuing bank approval for the credit card transaction to the payment terminal 14. Processing of the credit card transaction would occur via the credit card network as for other types of credit card transactions.

Interfacing programming code 26 is positioned on an electronic device of a user, such as a cellphone, that enables the user to communicate the identifier 18 and a credit card payment authorization 28 for the credit card transaction to the server 16 via the computer network 12. The server 16 then is positioned to initiate the credit card transaction.

The system 10 has several advantages over current systems. The user is enabled to initiate the credit card payment authorization 28 remotely on behalf of a third party. For example, a relative or acquaintance of the user may be in a situation where they are unable to make payment for a good, such as fuel, or a service. The relative or acquaintance may contact the user for assistance in making the payment. The relative or acquaintance provides the user with the identifier 18 for the payment terminal 14, such as a payment terminal 14 that is integral to a fuel pump. The interfacing programming code 26 enables the user to send the credit card payment authorization 28 for the transaction to the server 16 via the computer network 12, positioning the server 16 initiate the credit card transaction.

Another advantage of the system 10 is the ability of the user to access the system 10 on the user's own behalf in situations where doing so provides security or comfort to the user. For example, the user can send the credit card payment authorization 28 for a fuel purchase to the server 16 via the computer network 12 without exiting their vehicle during inclement weather to access the payment terminal 14 integral to a fuel pump.

The interfacing programming code 26 comprises facility identifying programming code 30 that is configured to present an identifier field 32 on a display of the electronic device of the user that enables the user to enter the identifier 18. The facility identifying programming code 30 is configured to enable presentation of a station number field 34 and a pump number field 36 on the display of the electronic device that enables the user to enter the station number 20 and the pump number 22, respectively, into the station number field 34 and the pump number field 36, as shown in FIG. 1.

The interfacing programming code 26 also comprises credit card programming code 38 that is configured to present a credit card number field 40, an expiration date field 42, a card verification value field 44, and an email address field 46 on the display of the electronic device of the user that enables the user to enter a credit card number, an expiration date, a card verification value, and an email address, respectively, as shown in FIG. 1.

The interfacing programming code 26 also comprises value programming code 48 that is configured to present a value field 50 on the display of the electronic device of the user that enables the user to enter a value that correspond to an amount of currency to be associated with the credit card payment authorization 28. The value programming code 48 enables the user to limit the amount of card payment transaction for the third party.

The interfacing programming code 26 also comprises security programming code 52 that is configured to present a pin field 54 on the display of the electronic device of the user requiring the user to enter a pin to actuate the interfacing programming code 26. The security programming code 52 provides a barrier to unauthorized use of the interfacing programming code 26.

A database 56 is positioned on the server 16. Data programming code 58 is positioned on the server 16 that enables the server 16 to store and retrieve the credit card number, the expiration date, the card verification value, and the email address of the user in the database 56. The server 16 is thus positioned to initiate processing of a subsequent credit card transaction, following submission of a subsequent credit card payment authorization 28 by the user, without the user being required to re-enter the stored information.

Transactional programming code 60 also is positioned on the server 16 that enables the server 16 to send a receipt for the credit card transaction to the email address of the user and to store a record 62 of the credit card transaction in the database 56.

Accounting programming code 64 is positioned on the server 16 that enables the server 16 to send an annual statement derived from the records 62 of the credit card transactions to the email address of the user. The accounting programming code 64 provides the annual statement to facilitate tax filing by the user.

In use, the user downloads and installs the interfacing programming code 26 on the electronic device of the user. After filling in the credit card number field 40, the expiration date field 42, the card verification value field 44, and the email address field 46 using the display of the electronic device, the user is positioned to send the credit card payment authorization 28 for the credit card transaction to the server 16 via the computer network 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

I claim:

1. A system for performing a credit transaction comprising:
a computer network;
a payment terminal having an identifier such that the payment terminal is uniquely identified, the payment terminal being in communication with the computer network;
a server in communication with the computer network;
processing programming code positioned on the server enabling the server for deriving a merchant bank identity from the identifier such that the server is configured for initiating processing of a credit card transaction and for communicating an issuing bank approval for the credit card transaction to the payment terminal; and
interfacing programming code positioned on an electronic device of a user enabling the user for communicating the identifier and a credit card payment authorization for the credit card transaction via the computer network to the server positioning the server for initiating the credit card transaction.

2. The system of claim 1, further including the interfacing programming code comprising:
facility identifying programming code configured for presenting an identifier field on a display of the electronic device of the user enabling the user for entering the identifier; and
credit card programming code configured for presenting a credit card number field, an expiration date field, a card verification value field, and an email address field on the display of the electronic device of the user enabling the user for entering a credit card number, an expiration date, a card verification value, and an email address, respectively.

3. The system of claim 2, further comprising:
the identifier comprising a station number and a pump number; and
the facility identifying programming code being configured for enabling presentation of a station number field and a pump number field on the display of the electronic device enabling the user for entering the station number and the pump number, respectively, into the station number field and the pump number field.

4. The system of claim 1, further including the interfacing programming code comprising value programming code configured for presenting a value field on the display of the electronic device of the user enabling the user for entering a value corresponding to a currency amount to be associated with the credit card payment authorization.

5. The system of claim 1, further including the interfacing programming code comprising security programming code configured for presenting a pin field on the display on the display of the electronic device of the user requiring the user for entering a pin for actuating the interfacing programming code.

6. The system of claim 2, further comprising:
a database positioned on the server; and
data programming code positioned on the server enabling the server for storing and retrieving the credit card number, the expiration date, the card verification value, and the email address of the user in the database positioning the server for initiating processing of a subsequent credit card transaction following submission of a subsequent credit card payment authorization by the user.

7. The system of claim 6, further including transactional programming code positioned on the server enabling the server for sending a receipt for the credit card transaction to the email address of the user and for storing a record of the credit card transaction in the database.

8. The system of claim 7, further including accounting programming code positioned on the server enabling the server for sending an annual statement of the credit card transactions to the email address of the user.

9. A system for performing a credit transaction comprising:
a computer network;
a payment terminal having an identifier such that the payment terminal is uniquely identified, the payment terminal being in communication with the computer network, the identifier comprising a station number and a pump number;
a server in communication with the computer network;
processing programming code positioned on the server enabling the server for deriving a merchant bank identity from the identifier such that the server is configured for initiating processing of a credit card transaction and for communicating an issuing bank approval for the credit card transaction to the payment terminal;
interfacing programming code positioned on an electronic device of a user enabling the user for communicating the identifier and a credit card payment authorization for the credit card transaction via the computer network to the server positioning the server for initiating the credit card transaction, the interfacing programming code comprising:
facility identifying programming code configured for presenting an identifier field on a display of the electronic device of the user enabling the user for entering the identifier, the facility identifying programming code being configured for enabling presentation of a station number field and a pump number field on the display of the electronic device enabling the user for entering the station number and the pump number, respectively, into the station number field and the pump number field,
credit card programming code configured for presenting a credit card number field, an expiration date field, a card verification value field, and an email address field on the display of the electronic device of the user enabling the user for entering a credit card number, an expiration date, a card verification value, and an email address, respectively,
value programming code configured for presenting a value field on the display of the electronic device of the user enabling the user for entering a value corresponding to a currency amount to be associated with the credit card payment authorization, and
security programming code configured for presenting a pin field on the display of the electronic device of the user requiring the user for entering a pin for actuating the interfacing programming code;
a database positioned on the server;
data programming code positioned on the server enabling the server for storing and retrieving the credit card number, the expiration date, the card verification value, and the email address of the user in the database positioning the server for initiating processing of a subsequent credit card transaction following submission of a subsequent credit card payment authorization by the user;
transactional programming code positioned on the server enabling the server for sending a receipt for the credit card transaction to the email address of the user and for storing a record of the credit card transaction in the database; and
accounting programming code positioned on the server enabling the server for sending an annual statement of the credit card transactions to the email address of the user.
